(19) United States
(12) Patent Application Publication
(10) Pub. No.: US 2010/0004947 A1
(43) Pub. Date: Jan. 7, 2010

(54) System and Method for Providing Health Management Services to a Population of Members

(76) Inventors: Michael Nadeau, Dallas, TX (US); Mark Head, Dallas, TX (US); David Smith, Coppell, TX (US); Jeff Brizzolara, Dallas, TX (US)

Correspondence Address: FOGARTY, L.L.C., P.O. Box 703695, Dallas, TX, 75370-3695, US

(21) Appl. No.: 12/165,777

(22) Filed: Jul. 1, 2008

(51) Int. Cl. G06F 19/00

(52) U.S. Cl. 705/3

(57) ABSTRACT

A preferred embodiment comprises providing heath management services by collecting member assessment data, collecting member biometric data, and generating risk factors for one or more members based upon the member assessment data and the member biometric data. The risk factors are analyzed using a set of rules to stratify the member population based upon risk and wellness coaching and outreach services are provided the population based upon risk levels.

### TECHNICAL FIELD

The present invention relates generally to systems and methods for providing health management services to and promoting wellness within a population of members and, more particularly, to systems and methods for identifying and acting on members based upon the members' risk levels.

### BACKGROUND

Traditional healthcare is focused upon disease management after patients have been diagnosed with an illness with minimal attention on trying to prevent disease in the first place. Patients seek medical services for diseases and illnesses that they are already experiencing. An insurance company or a medical provider may assign a case worker to a member or patient to assist in managing an existing disease. The case worker may assist the member in complying with a prescribed treatment plan. Insurance claims filed by members may be used by an insurance company to identify and select members who would benefit from assistance to manage a disease or illness. This approach may help to reduce medical costs associated with an existing disease or illness, but it does not provide disease prevention for members who are at risk for developing a disease or illness.

### SUMMARY OF THE INVENTION

These and other problems are generally solved or circumvented by embodiments of the present inventive system and method in which members' health management and wellness is promoted and encouraged by identifying members' risk levels and coaching members to participate in activities that reduce risk factors for disease and illnesses. The present inventive system and methods result in a population of members that is more healthy and that has a reduced need for disease management services and medical treatment. In turn this lowers the healthcare costs for the members.

In accordance with a preferred embodiment of the present invention, a method for providing health management services comprises collecting member assessment data, collecting member biometric data, and generating risk factors and a health score for one or more members based upon the member assessment data and the member biometric data. The risk factors are analyzed using a set of rules to identify high, moderate, and low-risk populations and wellness coaching is provided to each population.

In another embodiment, a method of providing health management services comprises selecting one or more individuals to be contacted regarding health management issues, the one or more individuals selected based upon at least one targeted risk factor, and contacting the one or more individuals via one or more communication formats selected from a plurality of communication formats. The selecting the one or more individuals may further comprise applying an outreach template to a group of health plan members, wherein the template identifies specific risk factors of interest and particular risk levels for the specific risk factors. The outreach template may be applied to the group of health plan members at periodic intervals. The group of health plan members may be associated with a common employer. The group of health plan members may be selected from a database of health plan members, and the database of health plan members may be associated with a plurality of employers and insurance providers. The one or more members may be stratified based upon risk levels of a risk factor in the template, and prioritized in a contact order based upon the members' risk level. The plurality of communication formats comprise: secure messaging, electronic mail, telephone communications, and postal mail. In other embodiments, outreach professionals and/or coaches may meet with members or communicate information to members in person, such as during on-site meetings at a member's place of employment or other location. Such on-site meetings may include workshops, health classes, health assessments or screenings, or group or one-on-one coaching.

In a further embodiment, a method for providing health management services comprises providing a database of member data, the member data comprising risk factors, risk levels and health scores for each of a plurality of members; applying an outreach template to the database to identify selected members, the template identifying particular risk factors and risk levels; and providing contact information for the selected members to one or more outreach professionals. The outreach information may be provided to the one or more outreach professionals, the outreach information associated with one or more of the particular risk factors. The outreach professionals may provide the outreach information to the selected members. The outreach information may be scripted text or a notification of a member assessment activity, for example.

In another embodiment, a method for providing health care cost information to a health care plan provider comprises analyzing health care claims data based upon member risk factors to develop a cost per risk factor per year for one or more risk factors. The cost per risk factor per year may be stratified based upon risk levels or cost. The cost per risk factor per year may be for an average for a group of employees or may be calculated for each employee within a group of employees. A comparison of a selected employer's cost per risk factor per year to a competitor's cost per risk factor per year may be provided.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an overview of one embodiment of a heath management and wellness service; and

FIG. 2 is a flowchart illustrating a method for implementing one embodiment of the present invention.

### DETAILED DESCRIPTION OF ILLUSTRATIVE EMBODIMENTS

The present invention provides many applicable inventive concepts that can be embodied in a wide variety of specific contexts. The specific embodiments discussed herein are merely illustrative of specific ways to make and use the invention, and do not limit the scope of the invention.

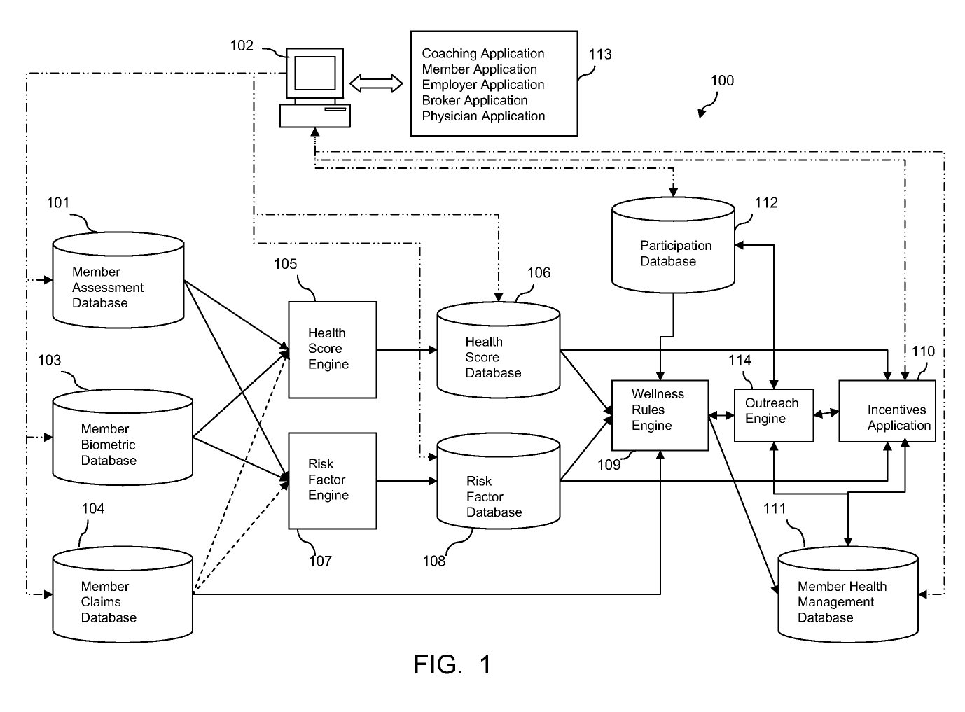

FIG. 1 illustrates one embodiment of health management system 100. Member assessment database 101 is collected for one or more members of a group, such as a group of employees or a group of health insurance plan members. The member assessment data may include, for example, information about the members' living, eating, working, exercising, and other activities and habits. Member assessment data 101 may be collected from members using any number of methods. For example, member assessment data may be collected using a survey or questionnaire filled out by the members. In one embodiment, an electronic survey or questionnaire may be accessed by members on-line via the Internet or any other public or private data network using, for example, terminal 102. Alternatively, in other embodiments, the members may fill out a paper or hardcopy survey to provide member assessment data. Questions in a member assessment survey may include, for example, questions directed to the members' age, sex, ethnicity, overall health, medications currently used, recent doctor visits, past and/or current illnesses, home and work environment, physical activity, use of tobacco products, and/or sleeping and eating habits. Generally, the member assessment data comprises subjective answers that are self-reported by the member.

Biometric data 103 may also be collected from the group members. Member biometric data 103 may include, for example, height, weight, blood pressure, heart rate, cholesterol levels, body mass index, and the like. The member biometric data 103 generally consists of objective data that may be collected, for example, by a health or medical professional at a clinic, doctor's office, place of employment or other location.

Member claim data 104 may also be collected for use in some embodiments of the present invention. Claim data may be collected directly from the members, from insurance companies, claim processing entities, and the like. Member claim data 104 may include information associated with health or other insurance claims filed by members. For example, member claims data 104 may include information regarding requests for coverage or reimbursement for medical services such as hospital, clinic, and/or doctor office visits and treatment, prescription medication costs, medical treatment, physical therapy, rehabilitation treatment, and the like.

Health score engine 105 receives or pulls information from member assessment database 101, member biometric database 103 and/or member claims database 104. Health score engine 105 generates a health score for one or more members. Health score engine 105 uses a health score algorithm that applies a weighted ranking to the assessment, biometric and claim information collected for the member. In one embodiment, a point value is assigned to each question or category in a member assessment survey and, after the member completes the survey, the health score algorithm calculates the member's score. For example, a question regarding whether the member is a smoker may be assigned a high point value if the answer is no and a low point value if the answer is yes. In other embodiments, a weighted point value may be assigned to the members' biometric data. For example, a point value may be assigned in direct or inverse proportion to the member's body mass index, cholesterol, blood pressure measurements, and/or other factors. Weighted point values may also be assigned to factors collected from member claims data, such as the cost and/or frequency of treatment, severity of injury or illness, and the like.

It will be understood that point values may be assigned to health score factors using any numerical range depending, for example, upon the granularity desired in the final health score. Moreover, it will be understood that relative size of the point values may represent either “good” or “bad” answers or measurements for the respective factors. For example, in a system using binary point values, a value of “0” may be assigned to answers or factors that are absent or lower than a desired threshold, while a value of “1” may be assigned if an answer or factor is present or higher than the desired threshold. On the other hand, in a system having more granularity, a value up to “100” may be assigned to answers or factors that are absent or lower than a desired threshold, while a value as low as “0” may be assigned if an answer or factor is present or higher than the desired threshold. Moreover, systems and methods embodying the present invention may use any number as the maximum or minimum, and any numerical range may separate the maximum and minimum values.

Health score engine 105 may add, average, or otherwise combine the point values assigned to the assessment, biometric measurements, and claims data to generate an overall member health score. The resulting member health score may be saved to health score database 106. The member, a health or medical professional, such as a doctor, an outreach professional, or a wellness coach may retrieve and view the member's health score using, for example, terminal 102. Member health score database 106 may store a plurality of health scores for a plurality of members. A member, wellness coach or outreach professional, for example, may view current and/or historical health scores for members. Additionally, the health scores for a group of members, such as an employee group, an insured group, or other collection of members, may be aggregated and viewed by an administrator, wellness coach, outreach professional or insurance agent. In one embodiment, outreach professionals may include registered dieticians, registered nurses, clinical professionals, and similar healthcare professionals.

Risk factor engine 107 may use data from member assessment database 101, member biometric database 103, and/or member claim database 104 to identify one or more risk factors for a member. Risk factor engine 107 may reference a pre-defined group of risk factors that are associated directly or indirectly with various ones of the factors in the member assessment database 101 and/or member biometric database 103. As used herein, the term risk factor is defined as some variable, parameter or thing that increases a person's chances of developing a disease. Risk factors may include, for example, activities or subjective choices of a member, such as use of tobacco products, eating habits; and/or objective parameters, such as a member's age, family history of certain diseases or types of cancer, obesity, and exposure to radiation or other cancer-causing agents. Risk factors may be correlated to certain diseases and illnesses, but are not necessarily the cause of the disease or illness.

Each of the questions or categories in a member assessment survey and each factor measured for the member's biometric data may be assigned both a health score point value and a risk factor value. Risk factor engine 107 analyzes the risk factors identified in the members assessment data and biometric data and generates a risk factor list for each member. For example, if a member has a high LDL cholesterol value (i.e. a high level of “bad” cholesterol), then the member's health score may be adversely affected and the member may be identified as having risk factors for clogged arteries and heart disease. Risk factors for members may be stored in risk factor database 108.

Risk factor engine 107 may use a unified set of core life style and biometric risk factors. Questions on a member assessment may be used to evaluate the life style risk factors and to assign a low, moderate or high risk to those factors. In one embodiment, questions directed to the types and amounts of food that a member eats, the frequency of the member's physical activity, and tobacco use may provide data to evaluate the member's life style risk factors. For example, if the member indicates tobacco use, then that user may be identified as being at high risk for certain types of cancer. Similarly, a medical screening, such as the member's blood pressure, cholesterol, or BMI measurements, may be used to identify biometric risk factors.

In some embodiments, only member assessment data and biometric data are used by health score engine 105 and risk factor engine 107. In other embodiments, health score engine 105 also uses member claim data. The connection between member claims database 104 and health score engine 105 and risk factor engine 107 is shown as a dashed line in FIG. 1 merely to indicate that information from database 104 may or may not be used in different embodiments.

Wellness rules engine 109 uses member health score data and member risk factor data to identify members who are at risk, identify members who need or would benefit from wellness coaching, and to monitor health and wellness status or activities. Wellness rules engine 109 may apply a set of pre-defined rules to the members' health score and risk factors and generate a list of high-risk members (i.e. a high-risk population) within the group of members. The high-risk population may be associated with specific risk factors or diseases, such as high blood pressure, high cholesterol, obesity, diabetes, or cancer.

Wellness rules engine 109 may provide data, such as a list of high-risk members, to outreach engine 114, which in turn provides data to incentives application 110. In one embodiment, incentives application 110 may be used to suggest, develop and manage incentives programs that are tailored to specific risk levels within the member population and that are designed to encourage those members to participate in wellness activities. A high-risk member, for example, may be offered a reward for performing a certain number of wellness tasks. In one embodiment, if the member participates in the suggested tasks, then they are eligible for the reward, such as entry into a drawing for a gift card, prize, or monetary award. In another embodiment, incentives application 110 may be used to assist a wellness coach to design, develop and manage challenges for the high-risk population. For example, a “biggest loser” challenge may be organized for a group of members who have a body mass index (BMI) above a certain threshold and who may improve their overall health by losing weight. Wellness rule engine 109 and outreach engine 114 may provide a list of members who have a BMI above the threshold to incentives application 110. Wellness rules engine 109 may also identify members who indicated an interest in losing weight. Outreach engine 114 and incentives application 110 may facilitate contacting and enrolling the members in the challenge and to monitor their progress.

Incentive programs may be developed, for example, in connection with an employer. The employer may use the incentives to achieve certain goals, such as reducing the overall risk of disease within the employee population. The incentive programs developed by incentives application 110 may be specifically targeted to particular disease categories, risk factors, member personalities, or other disease or member characteristics. Outreach engine 114 may identify members of the employers' health plan to be contacted about the incentive programs. Preferably, the incentive programs use techniques that support healthy activities or encourage member participation. One goal of the incentives programs is to drive and encourage participation in the available health management and wellness programs. The incentive programs may offer positive or negative incentives, such as a reduction or cancellation of insurance coverage if a member fails to participate in an assessment program or a lower insurance cost if the member's body mass index is below a selected level. A program that is helpful to one member, may not work for other members with different personalities, jobs, families, or physical characteristics. For example, some members may be more likely to participate in group programs, such as group walks or weight loss competitions, while other members are more responsive to individualized programs. To help a member reach wellness goals, incentive application 110 may adjust a member's incentive program if a particular program is not working for the member. Incentive application 110 may establish specific milestones for a member to meet as part of the incentive program. For example, incentive application 110 may set particular intervals, such as weekly or monthly periods, at which the member should meet certain goals, such as a number hours of exercise, a number of miles walked or run, or an amount of weight lost.

Member health management database 111, which is an aggregated database of member health metrics, may also receive information from wellness rules engine 109. Health management database 111 allows a wellness coach, outreach professional, or other user to store, sort and/or stratify member health data. Health management database 111 may also interact with incentives application 110 to provide data that would assist in the development of incentive programs for members. Data from health management database 111 may also be used to generate standardized or ad hoc reports regarding a selected population's health. Member health management database 111 may comprise records having specific data sets for each member, such as incentive programs used by the member, risk triggers, or coaching priority. Users may access, sort and search the data in member health management database 111, for example, to rank members by risk, health score, or claim costs. This information may be fed back to wellness rules engine 109 to further identify high-risk members or members who would benefit from coaching. The information in member health management database 111 is continually updated as members biometric data and assessment data changes and as the members participate in health management activities.

Participation database 112 stores information regarding members' participation and involvement in various activities, such as incentive programs, coaching, classes, or other training or activities. The information stored in participation database 112 may be used by wellness rules engine 109. For example, the wellness rules in engine 109 may determine whether a member has been participating in any incentive programs or wellness activities. If the member does not participate in the suggested activities or incentives, then wellness rules engine 109 may direct incentives application 110 to generate a different set of incentives for the member. Alternatively, wellness rules engine 109 or outreach engine 114 may notify a wellness coach or other healthcare professional that the member is not participating in certain activities and prompt the wellness coach to contact the member.

Outreach engine 114 may also exchange data with member health management database 111 and participation database 112. In one embodiment, outreach engine 114 uses the output of wellness rules engine 109 to provide “on-demand” services. An outreach professional may use data from outreach engine 114 to identify and/or prioritize members who should be contacted for health management services. Outreach engine 114 may generate automatic messages to members based on selected criteria, such as particular risk factors or health scores. Outreach engine 114 may also be used to generate telephone queues, scripts, and questions to be used by an outreach professional when contacting members.

Outreach engine 114 adds a human judgment element to the operation of the health management system. A particular group of members may be selected for promotional outreach, for example, such as employees of a company that is conducting member screening. Outreach engine 114 may also be used elevate or highlight the priority of selected risk factors. For example, a particular risk factor may be identified as a priority for health management during a particular wellness campaign or within a certain organization. Outreach engine 114 may provide outreach professionals with data identifying the members to be contacted in connection with selected risk factors. For example, outreach engine 114 may initiate or support outreach to all members, regardless of risk level, to provide promotional information, such as available programs, assessment or screening dates, or other general information. In another embodiment, outreach engine 114 may support lifestyle outreach to members in high and moderate risk levels, such as health improvement challenges or contests. Outreach engine 114 may further provide clinical outreach to members with high risk factors.

Health score engine 105, risk factor engine 107, wellness rules engine 109, incentives application 110 and outreach engine 114 may be embodied as a software applications running on a microprocessor device. In one embodiment, health score engine 105, risk factor engine 107, wellness rules engine 109, incentives application 110 and outreach engine 114 are components of a single software application that may run on a central server device. In other embodiments, two or more software applications running on two or more server or microprocessor devices may be used to provide the functionality for health score engine 105, risk factor engine 107, wellness rules engine 109, incentive application 110 and outreach engine 114. It will be understood that the system illustrated in FIG. 1 is not limited to the connections shown. Other connections among the illustrated components may be used in other embodiments. Moreover, some connections are shown as arrows for purposes of illustration only. It will be understood that information may flow in both directions on such connections despite the arrow pointing in one direction.

It will be understood that member assessment database 101, member biometric database 103, member claim database 104, health score database 106, and risk factor database 108 may be reside in separate devices, such as separate memory or storage systems. If configured in separate devices, member assessment database 101, member biometric database 103, member claim database 104, member health score database 106 and risk factor database 108 may be established in the same location or in locations that are remote from each other. Alternatively, all or any combination of the data stored in one or more of member assessment database 101, member biometric database 103, member claim database 104, health score database 106 and risk factor database 108 may be stored in the same memory device.

Terminal 102 may be located near to or remote from the other components illustrated in FIG. 1. Terminal 102 provides access for members, coaches, administrators, employers, brokers, physicians, and others to member data, health scores, risk factors, training courses and other information. Although only a single terminal 102 is illustrated, it will be understood that any number of terminals 102 may interact with health score engine 105, risk factor engine 107, wellness rules engine 109, coaching application 110, and outreach engine 114, as well as databases 101, 103, 104, 106, 108, 111, and 112. Terminal 102 may be connected via a public or private computer network to the other components illustrated in FIG. 1, or may be connected via a wireline or wireless connection.

Terminal 102 may be used to run one or more of applications 113, such as coaching, member, employer, broker or physician applications, that provide an interface between particular types of users and health management system 100.

A coaching application may be used by a wellness coach, outreach professional or healthcare professional to obtain a list of high-risk members and to identify activities suggested by wellness rules engine 109. The coaching application may be used to facilitate coaching of the high-risk population toward a healthier lifestyle. Additionally, the coaching application may provide automatic coaching to members of the high-risk population. A wellness coach may log-in to coaching application, such as by using terminal 102. The coaching application may provide the wellness coach or outreach professional with a list of tasks to accomplish with the high-risk population. The coaching application and/or the outreach professional may use incentives, challenges, training, reminders, feedback, and other member interaction. The coaching application may also generate suggested actions for the members who are participating in the challenge, such as dietary and exercise suggestions for the wellness coach or outreach professional to discuss with the participants.

A coaching application may also be configured to provide automated coaching, such as generating emails, letters, or text messages to members or secure messages to members having a common risk factor. The present invention provides HIPAA-compliant messaging, such as secure, 128-bit encrypted messaging for communicating medical, health, risk factor or individual coaching information to a member. For example, the coaching application may generate an email to a member having a high LDL cholesterol level to suggest particular foods that may help to improve cholesterol or to recommend avoiding other foods that would increase cholesterol levels. The coaching application may also assist the wellness coach in keeping track of high-risk members, such as by providing periodic or non-periodic reminders to follow-up with particular members.

The coaching application may also identify when a member's assessment, biometric or claim data is changed or updated. For example, if the member visits the doctor, new claim data 104 or biometric data 103 may be collected and forwarded to risk factor engine 107, which may identify new risk factors or may determine that certain risk factors have been reduced or eliminated. A member who has been identified with a high blood pressure risk factor, for example, may have a good blood pressure reading during a doctor visit. The coaching application may identify the change in the high blood pressure risk factor and notify the wellness coach or outreach professional, who may contact the member to provide positive feedback to the member and to encourage him to continue healthy activities.

In one embodiment, the present invention uses a combination of self-reported data, such as a member assessment, and objective data, such as biometric screening, to generate a list of risk factors for members. Wellness rules are applied to the risk factors to assist a wellness coach or outreach professional in identifying high-risk members. The wellness coach may then use the coaching application to stratify and group the high-risk members, such as by collecting data from member health management database 111. For example, a first group may be identified as potential participants in a challenge, such as a biggest loser competition; a second group may be identified for an incentive program, such as a drawing for a gift card if they run more than 5 miles a week; and a third group may be identified for reminder emails to eat healthy foods, such as certain vegetables. The coaching application may be used to manage a wellness program for a diverse group of members. The group may include members from different employers and/or different insurance plans.

In other embodiments, the coaching application may provide training and/or informational courses for use by a wellness coach, outreach professional, and/or member. For example, video, audio, interactive, static or other courses, information or training materials may be available through the coaching application. The course may be available to members who indicate an interest in learning about certain health or wellness topics, for example. Other members with specific risk factors may be notified of courses related to disease prevention. A wellness coach may want to learn about a new wellness program or refresh her knowledge about certain diseases. The members and/or wellness coach may access the courses using terminal 102, for example. Alternatively, the members or wellness coach may request that an electronic or paper copy of a selected course or training materials be sent to the user.

The members' health scores may be used, in one embodiment, to evaluate the effectiveness of a selected wellness coach. For example, a coach evaluation application may use individual member health scores and/or an aggregate member health score to determine if the programs being used by a particular coach are successful or not helpful to the members. The relative improvement of members' health scores may also be used to adjust wellness rules engine 109 and incentives application 110. Programs associated with low or no health score improvement may be canceled or modified. Additionally, the coach may receive feedback based upon the evaluation, which would help to improve the coach's performance and effectiveness.

A member application provides an interface that allows members to log onto the system using a terminal such as 102. The members may monitor their health scores and risk factors using the member application. Additionally, members may use the member application to participate in incentive programs, communicate with wellness coaches, use training materials and other components of system 100.

An employer application and an insurance broker application may also be used to interface with system 100. For example, an employer or broker may review individual and aggregate member health scores. Member health scores and risk factors for a group may be used to determine the type of insurance premiums and plans that should be considered for that group. The member health scores may be analyzed by an employee, member, employer, coach, or broker. If an employee group does or does not have certain risk factors, then the availability and cost of coverage for diseases associated with that risk factor in various insurance plans may be relevant to the employer when selecting insurance coverage.

In one embodiment, risk factors may be identified using claims data for a group, such as a group of employees. Claims data may be obtained from companies that analyze and process insurance claims. The raw claims data may be processed by health score engine 105 to generate health scores for a group. The raw claims data for a group also may be used by risk factors engine 107 to generate a list of risk factors for the group or for individual members. The overall risk for the group may be evaluated using the risk factor data generated by engine 107.

The claims data may be used to compare health cost spending among different companies. For example, the cost per employee per year may be calculated for one or more companies. Those costs may be compared between competitor companies, for example, so that a company may evaluate its own healthcare or insurance spending against industry benchmarks. The claims data and the members' risk factors and health scores may also be used to correlate risk factors to healthcare costs. This would allow employers, for example, to evaluate what risk factors are driving their healthcare costs and to determine what factors comprise the healthcare costs. The costs for members may be further stratified based upon risk factor so that an employer may evaluate the cost per employee per risk factor per year, so that the employer may identify the highest cost risk factors. Those high-cost risk factors may be then used by outreach engine 114 and/or incentives application 110 to identify employees to be targeted for outreach programs that are aimed at reducing and managing the high-cost risk factors. This would provide the employer with tools for managing and reducing future healthcare costs.

An employer or broker application may provide cost-based analytics using the health management, risk factor and claims data. The cost-based analytics provide an analysis of healthcare costs based on stratifications of the employees' risk factors. The cost-based analytics would help to calculate the employer's return on its investment in healthcare costs by showing whether the employer's health plan has been successful in reducing high-cost risk factors and in reducing predicted healthcare costs associated with those risk factors.

Physicians or other healthcare professionals may also access system 100 using a physician application. Physicians may use the application to enter data, such as member biometric data, or to review members' health scores, risk factors, or incentive programs.

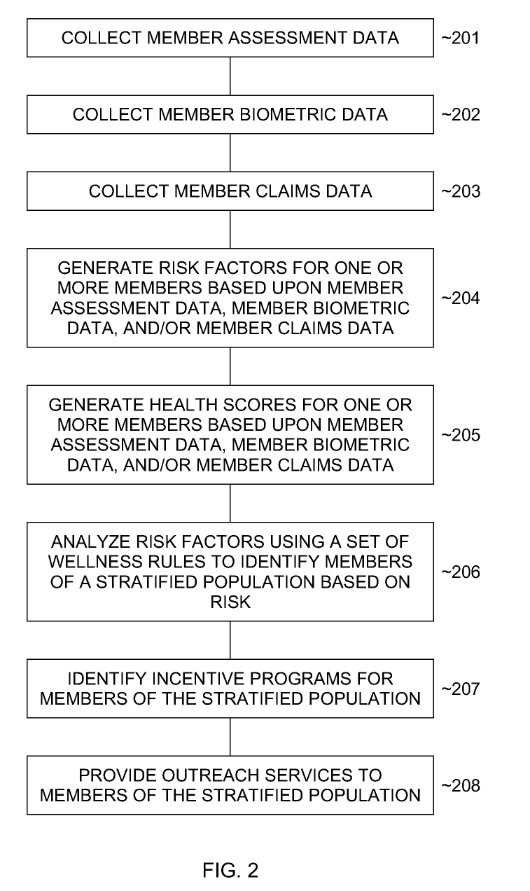

FIG. 2 is a flowchart illustrating a method for implementing one embodiment of the present invention. In step 201, member assessment data is collected, such as using an on-line or hard copy questionnaire or survey. In step 202, member biometric data is collected, such as during a medical check-up or assessment examination. In step 203, member claims data is collected, such as from a claims processing service or insurance company. In step 204, risk factors are generated for one or more members based upon the member assessment data, member biometric data, and/or member claims data. In step 205, health scores for one or more members are generated based upon the member assessment data, member biometric data, and/or member claims data. The health scores and risk factors may be stored for later use, such as for evaluating the current or historical health of a member or group of members. A wellness coach, outreach professional, member, administrator, insurance broker, or other party may have access to the health scores for analysis.

The health scores and risk factors may be stored for use by other applications, such as in step 206 in which the risk factors are analyzed using a set of wellness rules to identify members of a population stratified based on risk. The population may be stratified into low, moderate and high-risk members. High-risk members may include, for example, members who have a plurality of risk factors for a particular disease, or who have one or more key risk factors for the disease. The wellness rules may be configured to assist in evaluating the number and/or importance of the risk factors to identify a higher likelihood that a member may develop the disease. The health management services provided using the present invention may be used in some embodiments to also help low and moderate-risk members from developing additional key risk factors that would put them in a high-risk category.

In step 207, incentive programs are identified for members of the stratified population. An incentive application may use information from a wellness rules engine and/or a member health management database to select or develop the incentive programs. In step 208, a wellness coach, outreach professional or other individual may then provide outreach services to members of the stratified population. The services may be selected based upon the risk levels of various members of the population. The outreach professional may monitor or support the incentive programs or other activities, such as challenges, courses, or email and text messages. A coaching application may be used by the wellness coach or outreach professional to identify members who are eligible for and likely to benefit from coaching. The coaching application may also provide tools to assist the wellness coach or outreach professional to design, implement, and manage wellness programs for members.

For example, a member may submit an assessment, participate in a biometric examination, and/or approve the release of claim data. In one embodiment, the risk factor engine may determine that member's assessment and/or biometric data indicates that the member has a high risk for diabetes, such as a family history of the disease or a high blood sugar measurement. The wellness rules may suggest that the member should have a glucose tolerance test. If the member's claim data indicates that he or she has not yet had a glucose tolerance test or other follow-up regarding diabetes, then the coaching application 113 or outreach engine 114 may prompt the wellness coach to contact the member to suggest such a follow-up. The incentive application may suggest that the wellness coach recommend a course on diabetes to the member or suggest other information to be sent to the member in an email or text message.

In other embodiments, if a member is identified as having high cholesterol, he may be identified as being in a high-risk group. The wellness rules may suggest that the member see a doctor about the problem and/or have a prescription for cholesterol reducing medication. If there is no indication that the member has taken these steps, then the coaching application 113 or outreach engine 114 may suggest that the wellness coach or outreach professional contact the member and/or provide the member with information regarding the effects of high cholesterol levels and ways to reduce those levels.

In another embodiment, female members over age 40 who have not had a recent breast cancer screening may be assigned to a high risk category by the risk factors engine. The coaching application 113 or outreach engine 114 may automatically send email or text messages to women in this group, or suggest that the wellness coach or outreach professional contact these women, to suggest they schedule a mammogram.

A method for providing health management and/or wellness services may comprise collecting member health assessment data and member biometric data. A health score and risk factors for each member are identified based upon the member assessment data and the member biometric data. A high-risk population is then identified by applying a set of wellness rules to the health scores and risk factors. One or more incentive programs may be selected for the high-risk population. A wellness coach may also provide coaching to the high-risk population to participate in an incentive program or other wellness or health management activity. The coach may encourage the members to participate in competitions, challenges, exercise programs, nutrition programs, and/or educational programs. The members' participation in incentive programs may be monitored and used to refine the incentive programs recommended to the members. Other incentive programs may be developed for other risk groups, such as members at moderate and low risk, to encourage those members to maintain a reduced risk level.

The member health assessment data may include, for example, a members' self-evaluation of various health metrics such as the members' nutrition, physical activity, stress, tobacco use, alcohol use and sleep habits. The health assessment data may be collected using one or more questions directed to each of these health metrics. The potential answers to each of the health metric questions may be assigned a health score point value. The point values for each of a member's answers may be added or otherwise combined to calculate the member's health score. Additionally, the potential answers to each of the health metric questions may be assigned a risk level. The risk level for each of a member's answers may be evaluated to identify the member's risk factors. For example, a health assessment survey may include health metric questions directed to the member's nutrition, such as a question related to how often the member drinks at least eight 8-ounce glasses of water a day. Each of the answers options may be assigned a risk level and a health score point value, as illustrated in the example of Table 1.

TABLE 1
Q: On average, how many days each week do you drink
at least eight 8-ounce glasses of water?

| Answer choice | Risk Level | Point Value |
|---|---|---|
| 0 | High | 0.24 |
| 1 | High | 0.24 |
| 2 | High | 0.24 |
| 3 | Moderate | 0.42 |
| 4 | Moderate | 0.42 |
| 5 | Low | 0.60 |
| 6 | Low | 0.60 |
| 7 | Low | 0.60 |

Table 2 illustrates another exemplary risk level and health score point value assignment for another health metric question related to tobacco use. The user is presented with several possible answer and each option is assigned a relative health score point value and risk level value.

TABLE 2
Q: How often do you use tobacco products such as
cigarettes, cigars, pipes, snuff, chewing tobacco, etc.?

| Answer choice | Risk Level | Point Value |
|---|---|---|
| Daily | High | 0.56 |
| Occasionally | High | 1.12 |
| Rarely | Moderate | 6.86 |
| Never | Low | 9.80 |

It will be understood that any number of questions may be associated with a particular health metric and that different numbers of questions may be used for different health metrics depending on how specifically a wellness or health management provider wants to evaluate each individual health metric. For example, one question may be used to evaluate overall tobacco use, such as shown in Table 2, or the health assessment survey may use multiple questions, each directed to the use of specific tobacco products.

The member biometric data may comprise objective measurements of a member's medical factors, such as blood pressure, cholesterol level, triglycerides level, glucose level, and body mass index. These measurements may be made by a healthcare or wellness professional and/or collected from laboratory analysis of the member's blood sample or other specimens. Each biometric parameter measured in the biometric data may be divided into different measurement ranges. The different ranges may be assigned a health score point value. The point values for each of the member's biometric data measurements may be added or otherwise combined to calculate the member's health score. The different measurement ranges for the measured health factors may also be assigned a risk level. The risk levels for the biometric data measurements may be evaluated to identify the member's risk factors.

Table 3 illustrates a risk level and health score point value assignment for a health factor related to the member's total cholesterol. The measured cholesterol value, such as determined by laboratory analysis of the member's blood specimen, will fall within one of the specified ranges. The member's total cholesterol measurement is assigned a corresponding risk level and health score point value, as illustrated in the example of Table 3.

TABLE 3
Total Cholesterol

| Measurement | Risk Level | Point Value |
|---|---|---|
| <200 | Low | 3.00 |
| 200-240 | Moderate | 2.10 |
| >240 | High | 1.20 |

Other biometric measurements may be evaluated and assigned risk levels and health score point values, such as blood pressure measurements, glucose measurements, and BMI calculations. These factors may be evaluated using more specific measurements, such as specific LDL cholesterol and HDL cholesterol measurements, or ratios between different factors or measurements.

It will be understood that the risk level values and health score point values that are assigned to health assessment survey questions and to biometric measurements may be generic for both sexes and all races and ages. Alternatively, age-, race-, and/or sex-range specific values may be established for individual survey questions or biometric measurements if it is determined that a particular health factor or biometric has varying significance to different members of the population. Accordingly, the health score point values and risk level values may be further refined for specific groups of the population. For example, it might be determined that the impact of tobacco use on health varies depending upon age, the impact of alcohol use on health varies depending upon sex, and the impact of glucose levels on health varies depending on race. For each of these factors, age-, sex-, and race-specific health score point value and risk level value assignments may be developed.

The health score points for each health survey question and biometric may be combined to generate a member health score. As illustrated in Table 4, the point values for the member's answers to health survey questions, such as the member's answers to the questions in Tables 1 and 2 above, are added together with the point values assigned to the member's other survey answers. Additionally, as shown in Table 4, the point values for the member's biometric measurements, such as the biometric data for the total cholesterol biometric in Table 3, are also added to the health survey point values to give the overall member health score.

The health assessment health score points and the biometric health score points may be weighted separately to calculate the total health score. For example, if the heath management provider determines that the biometric data is overall more important to the health score determination than the health assessment questions, then the biometric measurements may be weighted more in calculating the total health score. As illustrated in Table 4, the biometric data may be weighted as 60% of the total health score and the health assessment data as 40% of the total in one embodiment. Table 4 is intended as an illustration of exemplary health survey questions and biometric measurements used to calculate a member's total health score. The point values and total health score in Table 4 are merely presented for illustration and are not intended to be limiting features of the invention. In one embodiment of the invention, for example, 20 health survey questions and multiple biometric measurements may be used and point values assigned so that the typical health score is on a scale from 0 to 100.

TABLE 4
Member #1

| | | Risk Level | Point Value |
|---|---|---|---|
| Health Survey | Water intake question | Moderate | 0.42 |
| Questions | Tobacco use question | High | 0.56 |
| | Question #3 | Low | *** |
| | Question #4 | Moderate | *** |
| | Question #5 | High | *** |
| | Sub total | | ### |
| Biometric | Total Cholesterol | Low | 3.00 |
| Measurements | Biometric #2 | Low | *** |
| | Biometric #3 | Moderate | *** |
| | Biometric #4 | High | *** |

| | |
|---|---|
| Sub total | ### |

| | |
|---|---|
| Health Assessment Adjustment (40% of total) | *** |
| Biometric Adjustment (60% of total) | *** |
| Total Health Score | 85.50 |

The member's risk factors may also be identified from the summary information shown in Table 4. For example, the member is at high-risk for health issues related to tobacco use. The member is also at high risk for health issues related to the subject matter of question #5 and biometric #4. Question #5 may be directed, for example, to physical activity, and the member's answers indicated little or no exercise. Biometric #4 may be directed, for example, to glucose levels, and the member's blood work may indicate high glucose levels.

Table 4 is merely an exemplary summary of the health assessment data and risk factor data collected for one member. As noted above, it will be understood that any number of questions may be included in a health assessment survey, and that any number of biometric parameters may be measured in embodiments of the invention. Moreover, the relative point value and risk level associated with each question and biometric may be adjusted by the health management provider as appropriate.

A set of wellness rules may be applied to the member's health score (e.g. 85.50) and risk factors (e.g. tobacco, physical activity, and glucose levels). The wellness rules may provide data to an incentive application (FIG. 1), which would develop incentives to help the member reduce his risk factors. For example, the incentives engine may suggest activities, classes, or support to help the member reduce tobacco use, to begin exercising, and to follow a diet that would lower glucose levels.

The data illustrated in Tables 1-4 for a single member may be collected, measured and calculated for a plurality of members, such as a group of employees. The wellness rules may be used to identify and stratify members by risk factor, such as by identifying how many members are at high risk for each factor and identifying which members have the most high risk factors. Table 5 illustrates an exemplary summary of the health risks for a population of users, such as an employee group, across six risk factor categories.

The health management system may be used to identify the members of the high risk group in each risk factor category. Those members may be specifically targeted for coaching to lower their risk factor for those specific categories and thereby lower their likely of becoming ill, developing a disease and/or requiring medical care.

TABLE 5

Risk Levels and Number of
Participants in Category

| Risk Factor Categories | High | Moderate | Low | Total |
|---|---|---|---|---|
| Tobacco | 117 | 21 | 141 | 279 |
| Physical Activity | 107 | 125 | 47 | 279 |
| Glucose | 38 | 93 | 148 | 279 |
| Total Cholesterol | 40 | 48 | 191 | 279 |
| Factor #5 | 50 | 180 | 49 | 279 |
| Factor #6 | 100 | 166 | 13 | 279 |
| Factor #7 | 154 | 92 | 33 | 279 |
| Factor #8 | 19 | 118 | 142 | 279 |
| Factor #9 | 45 | 136 | 98 | 279 |

Table 6 illustrates an exemplary population analysis for a group of members, such as an employee group. The data in Table 6 is stratified by risk to illustrate the distribution of risk factors among the members. If a member has a risk level of high for any of the categories, then the member is considered to have a risk factor for that category. The number of risk factors column indicates that among the illustrated group, the members had on average 3.9 risk factors. Four members had no risk factors, and five member had all nine identified risk factors. The health management system may be used to identify members who have an overall high risk level, such as members with 5 more risk factors. Those members may be targeted for coaching to reduce their risk factors and to improve their overall health. The coaching may be tailored to the particular group of risk factors associated with that each individual.

TABLE 6

| Member | Number of Risk | Number of | Percentage of |
|---|---|---|---|
| Risk Level | Factors | Members | Members |
| Total | 3.9 Average | 274 | 100.0% |
| Low | 0 | 4 | 1.5% |
| | 1 | 29 | 10.6% |
| | 2 | 45 | 16.4% |
| Moderate | 3 | 45 | 16.4% |
| | 4 | 47 | 17.2% |
| High | 5 | 52 | 19.0% |
| | 6 | 29 | 10.6% |
| | 7 | 10 | 3.6% |
| | 8 | 8 | 2.9% |
| | 9 | 5 | 1.9% |

In another embodiment, the risk factors may be individually weighted so that selected critical risk factors are prioritized. Such weighting of risk factors may result in more members falling in a moderate or high risk group. By weighting certain risk factors, embodiments of the present invention may be used to identify the possibility of and to prevent “risk migration” in which members' risk factors become worse over time.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing health management services, comprising:
collecting member health assessment data;
collecting member biometric data;
identifying risk factors for each members based upon the member assessment data and the member biometric data;
calculating a health score for each member based upon the member health assessment data and the member biometric data;
stratifying a member population by applying a set of rules to the health scores and risk factors; and
selecting one or more outreach programs for the population based upon member risk levels.

2. The method of claim 1, further comprising:
selecting a group of members for health management coaching based upon the members' risk levels.

3. The method of claim 2, wherein the coaching comprises encouraging one or more members to participate in one or more of the following:
competitions;
challenges;
exercise programs;
nutrition programs; and
educational programs.

4. The method of claim 1, further comprising:
monitoring members' participation in incentive programs.

5. The method of claim 1, wherein member health assessment data comprises members' self-evaluation of the members' own health, nutrition, physical activity, stress, tobacco use, alcohol use and sleep habits.

6. The method of claim 5, wherein health assessment data is collected using one or more questions, wherein potential answers to each of the one or more questions are assigned a point value, and wherein the point values for each of a member's answers are combined while calculating the member's health score.

7. The method of claim 5, wherein health assessment data is collected using one or more questions, wherein potential answers to each of the one or more questions are assigned a risk level, and wherein the risk level for each of a member's answers are evaluated when identifying the member's risk factors.

8. The method of claim 1, wherein the member biometric data comprises objective measurement of individual members' blood pressure, cholesterol, triglycerides, glucose, and body mass index.

9. The method of claim 8, wherein different measurement ranges of biometric data are assigned a point value, and wherein the point values for each of a member's biometric data measurements are combined while calculating the member's health score.

10. The method of claim 8, wherein different measurement ranges of biometric data are assigned a risk level, and wherein the risk levels for each of a member's biometric data measurements are evaluated when identifying the member's risk factors.

11. A method of providing health management services, comprising:
selecting one or more individuals to be contacted regarding health management issues, the one or more individuals selected based upon at least one targeted risk factor; and
contacting the one or more individuals via one or more communication formats selected from a plurality of communication formats.

12. The method of claim 11, wherein the selecting the one or more individuals further comprises:
applying an outreach template to a group of health plan members, wherein the template identifies specific risk factors of interest and particular risk levels for the specific risk factors.

13. The method of claim 12, further comprising:
applying the outreach template to the group of health plan members at periodic intervals.

14. The method of claim 12, wherein the group of health plan members are associated with a common employer.

15. The method of claim 12, wherein the group of health plan members selected from a database of health plan members; and wherein the database of health plan members are associated with a plurality of employers and insurance providers.

16. The method of claim 12, further comprising:
stratifying the one or more members based upon risk levels of a risk factor in the template; and
prioritizing a contact order for the one or more members to be contacted based upon the members' risk level.

17. The method of claim 11, wherein the plurality of communication formats comprise: secure messaging, electronic mail, telephone communications, and postal mail.

18. A method for providing health management services, comprising:
providing a database of member data, the member data comprising risk factors, risk levels and health scores for each of a plurality of members;
applying an outreach template to the database to identify selected members, the template identifying particular risk factors and risk levels; and
providing contact information for the selected members to one or more outreach professionals.

19. The method of claim 18, further comprising:
providing outreach information to the one or more outreach professionals, the outreach information associated with one or more of the particular risk factors;
providing the outreach information to the selected members by the outreach professional.

20. The method of claim 19, wherein the outreach information is scripted text.

21. The method of claim 20, wherein the outreach information is notification of a member assessment activity.

22. A method for providing health care cost information to a health care plan provider, comprising:
analyzing health care claims data based upon member risk factors to develop a cost per risk factor per year for one or more risk factors.

23. The method of claim 22, further comprising:
stratifying the cost per risk factor per year based upon risk levels.

24. The method of claim 22, further comprising:
stratifying the cost per risk factor per year based upon cost.

25. The method of claim 22, wherein the cost per risk factor per year is an average for a group of employees.

26. The method of claim 22, wherein the cost per risk factor per year is calculated for each employee within a group of employees.

27. The method of claim 22, further comprising:
providing a comparison of a selected employer's cost per risk factor per year to a competitor's cost per risk factor per year.
